(19) United States
(12) Patent Application Publication
(10) Pub. No.: US 2025/0384873 A1
(43) Pub. Date: Dec. 18, 2025

(54) DISPLAY DEVICE

(71) Applicant: LG ELECTRONICS INC., Seoul (KR)

(72) Inventor: Seunghyun HEO, Seoul (KR)

(73) Assignee: LG ELECTRONICS INC., Seoul (KR)

(21) Appl. No.: 18/879,694

(22) PCT Filed: Jun. 29, 2022
(86) PCT No.: PCT/KR2022/009357

§ 371 Date: Dec. 27, 2024

(51) Int. Cl. G10L 15/05; G10L 15/18; G10L 15/22; G10L 15/26; G10L 15/30; H04N 21/422

(52) U.S. Cl. CPC G10L 15/05; G10L 15/18; G10L 15/1815; G10L 15/22; G10L 15/26; G10L 15/30; G10L 2015/223; H04N 21/42203; H04N 21/42222

(57) ABSTRACT

The present disclosure relates to a display device capable of accurately recognizing an end point of a speech input of a user, and the display device may comprise a network interface which communicates with a first server and a second server, and a controller which: acquires a speech input of a user; transmits, to the first server, a speech signal corresponding to the acquired speech input; receives, from the first server, the energy level of the speech signal, text corresponding to the speech input, and speech end point information for the speech input; and determines whether an utterance of the user has ended on the basis of the energy level and the speech end point information.

### TECHNICAL FIELD

The present disclosure relates to a display device, and more specifically, to a display device providing a speech recognition service.

### BACKGROUND TECHNOLOGY

Digital TV services using wired or wireless communication networks are becoming widespread. Digital TV services can provide various services that were not available with existing analog broadcasting services.

For example, Internet Protocol Television (IPTV) and smart TV services, which are types of digital TV services, provide interactivity that allows users to actively select the type of viewing program, viewing time, etc. The IPTV and smart TV services can also provide various additional services, such as Internet search, home shopping, and online games, based on this interactivity.

Recent TVs provide speech recognition services based on user speech recognition. When speech input is made through a microphone button equipped on the TV remote control, the start and end of the user input can be recognized through the press/release of the button.

However, in cases where the end of the user's speech cannot be known, such as when using a wake-up word for a long-distance speech command or when using a speech button on a virtual keyboard, the signal size information (e.g., Amplitude, Energy strength) is utilized to recognize the end of the speech input.

However, conventional technologies do not recognize the end of the speech as intended by the user when there is noise or other sounds around, and continue to receive speech input.

Even when the user has finished the speech input, the TV continues to receive speech input without knowing it, and outputs an undesired speech recognition result.

Accordingly, the user may feel considerable inconvenience in the process of receiving the speech recognition service.

### DETAILED DESCRIPTION OF THE INVENTION

### Technical Problem

The present disclosure is to provide a display device that can accurately recognize the endpoint of the user's speech input.

The present disclosure is to provide an accurate speech recognition service by utilizing the energy level of the speech input and the endpoint information of the speech input.

### Technical Solution

A display device according to an embodiment of the present disclosure may include a network interface communicating with a first server and a second server; and a controller configured to obtain a speech input of a user, transmit a speech signal corresponding to the obtained speech input to the first server, receive an energy level of the speech signal, a text corresponding to the speech input, and utterance endpoint information for the speech input from the first server, and determine whether an utterance of the user has ended based on the energy level and the utterance endpoint information.

A display device according to another embodiment of the present disclosure may include a network interface communicating with a first server and a second server; and a controller configured to obtain a speech of a user, transmit a speech signal corresponding to the obtained speech input to the first server, receive an energy level of the speech signal and a text corresponding to the speech input from the first server, transmit the text to the second server, receive utterance endpoint information for the speech input from the second server, and determine whether a utterance of the user has ended based on the energy level and the utterance endpoint information.

### Effect of the Invention

According to an embodiment of the present disclosure, an end of speech can be accurately recognized by using text analysis and energy level for speech input. Accordingly, unnecessary speech recognition can be prevented from being performed.

According to an embodiment of the present disclosure, an end of a user's speech can be accurately determined by using an energy level, speech endpoint information, and analysis result information for the user's speech input. Accordingly, even if the user has ended the speech input, speech recognition due to noise can be prevented, and an accurate speech recognition service can be provided according to the end of the speech input.

### BRIEF DESCRIPTION OF THE DRAWINGS

FIG. 1 is a block diagram illustrating a configuration of a display device according to an embodiment of the present invention.

FIG. 2 is a block diagram of a remote control device according to an embodiment of the present invention.

FIG. 3 illustrates an example of an actual configuration of a remote control device according to an embodiment of the present invention.

FIG. 4 illustrates an example of utilizing a remote control device according to an embodiment of the present invention.

FIG. 5 is a diagram explaining a process for recognizing an endpoint of a speech input according to a conventional technology.

FIG. 6 is a ladder diagram explaining a method of operating a system according to an embodiment of the present disclosure.

FIG. 7 is a diagram explaining a process of detecting an endpoint of an utterance and performing an intention analysis according to an embodiment of the present disclosure.

FIG. 8 is a diagram explaining a process of generating an utterance endpoint information by an endpoint detector according to an embodiment of the present disclosure.

FIG. 9 is a ladder diagram explaining a method of operating a system according to another embodiment of the present disclosure.

FIG. 10 is a diagram explaining a process of detecting an endpoint of an utterance and performing an intention analysis according to another embodiment of the present disclosure.

### BEST MODE

Hereinafter, embodiments related to the present invention will be described in more detail with reference to the drawings. The suffixes “module” and “part” used for components in the following description are given or used interchangeably only for the convenience of writing the specification, and do not have distinct meanings or roles in themselves.

The display device according to the embodiment of the present invention is, for example, an intelligent display device that adds a computer-assisted function to the broadcast reception function, and while remaining faithful to the broadcast reception function, it can have an interface that is more convenient to use, such as a manual input device, a touch screen, or a space remote control, by adding an Internet function, etc. In addition, it can perform functions such as email, web browsing, banking, or games by connecting to the Internet and a computer with the support of wired or wireless Internet functions. A standardized general-purpose OS can be used for these various functions.

Therefore, the display device described in the present invention can perform various user-friendly functions, for example, since various applications can be freely added or deleted on a general-purpose OS kernel. The above display device may be, more specifically, a network TV, HBBTV, smart TV, LED TV, OLED TV, etc., and may be applied to a smartphone in some cases.

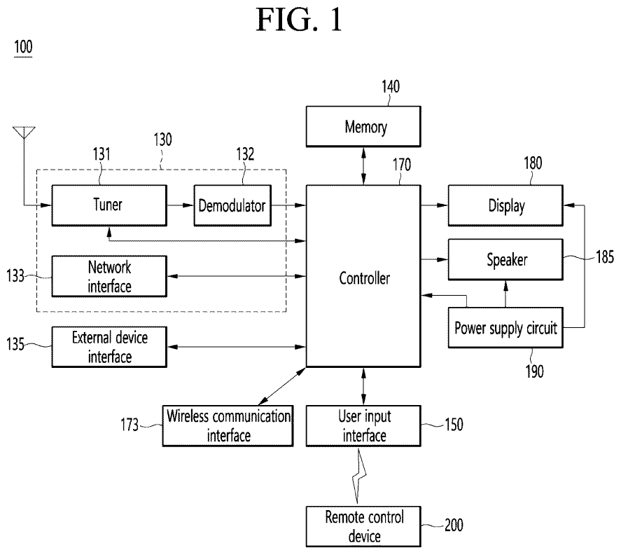

FIG. 1 is a block diagram illustrating the configuration of a display device according to an embodiment of the present invention.

Referring to FIG. 1, the display device 100 may include a broadcast receiving unit 130, an external device interface 135, a memory 140, a user input interface 150, a controller 170, a wireless communication interface 173, a display 180, a speaker 185, and a power supply circuit 190.

The broadcast receiving unit 130 may include a tuner 131, a demodulator 132, and a network interface 133.

The tuner 131 may select a specific broadcast channel according to a channel selection command. The tuner 131 can receive a broadcast signal for a specific broadcast channel that has been selected.

The demodulator 132 can separate the received broadcast signal into a video signal, an audio signal, and a data signal related to a broadcast program, and restore the separated video signal, audio signal, and data signal into a form that can be output.

The external device interface 135 can receive an application or an application list in an adjacent external device and transmit it to the controller 170 or the memory 140.

The external device interface 135 can provide a connection path between the display device 100 and the external device. The external device interface 135 can receive one or more of images and audio output from an external device connected wirelessly or by wire to the display device 100 and transmit it to the controller 170. The external device interface 135 can include a plurality of external input terminals. The plurality of external input terminals may include an RGB terminal, one or more High-Definition Multimedia Interface (HDMI) terminals, and a component terminal.

An image signal of an external device input through the external device interface 135 may be output through the display 180. An audio signal of an external device input through the external device interface 135 may be output through the speaker 185.

An external device that can be connected to the external device interface 135 may be any one of a set-top box, a Blu-ray player, a DVD player, a game console, a sound bar, a smartphone, a PC, a USB memory, and a home theater, but this is only an example.

The network interface 133 may provide an interface for connecting the display device 100 to a wired/wireless network including the Internet. The network interface 133 may transmit or receive data with another user or another electronic device through the connected network or another network linked to the connected network.

In addition, some content data stored in the display device 100 can be transmitted to another user or another electronic device selected from among users or electronic devices pre-registered in the display device 100.

The network interface 133 can access a predetermined web page through the connected network or another network linked to the connected network. That is, it can access a predetermined web page through the network and transmit or receive data with the corresponding server.

In addition, the network interface 133 can receive content or data provided by a content provider or a network operator. That is, the network interface 133 can receive content such as movies, advertisements, games, VOD, broadcast signals, etc., and information related thereto provided from a content provider or a network provider through the network.

In addition, the network interface 133 can receive update information and update files of firmware provided by the network operator, and can transmit data to the Internet or content provider or network operator.

The network interface 133 can select and receive a desired application from among applications open to the public through the network.

The memory 140 can store programs for each signal processing and control within the controller 170, and can store processed images, speeches, or data signals.

In addition, the memory 140 can perform a function for temporary storage of images, speeches, or data signals input from an external device interface 135 or a network interface 133, and can store information about a given image through a channel memory function.

The memory 140 can store an application or an application list input from an external device interface 135 or a network interface 133.

The display device 100 can play content files (video files, still image files, music files, document files, application files, etc.) stored in the memory 140 and provide them to the user.

The user input interface 150 can transmit a signal input by the user to the controller 170 or transmit a signal from the controller 170 to the user. For example, the user input interface 150 can receive and process control signals such as power on/off, channel selection, and screen setting from the remote control device 200 according to various communication methods such as Bluetooth, WB (Ultra Wideband), ZigBee, Radio Frequency (RF) communication method, or infrared (IR) communication method, or process the control signals from the controller 170 to be transmitted to the remote control device 200.

In addition, the user input interface 150 can transmit a control signal input from a local key (not shown) such as a power key, a channel key, a volume key, a setting value, etc. to the controller 170.

An image signal processed by the controller 170 can be input to the display 180 and displayed as an image corresponding to the image signal. In addition, an image signal processed by the controller 170 can be input to an external output device through an external device interface 135.

An audio signal processed by the controller 170 can be output as audio to a speaker 185. In addition, an audio signal processed by the controller 170 can be input to an external output device through an external device interface 135.

In addition, the controller 170 can control the overall operation within the display device 100.

In addition, the controller 170 can control the display device 100 by a user command or an internal program input through the user input interface 150, and can allow the user to download a desired application or application list into the display device 100 by connecting to a network.

The controller 170 can allow the user-selected channel information, etc. to be output through the display 180 or speaker 185 together with the processed image or audio signal.

In addition, the controller 170 can allow the image signal or audio signal from an external device, such as a camera or camcorder, input through the external device interface 135 to be output through the display 180 or speaker 185 according to the external device image playback command received through the user input interface 150.

Meanwhile, the controller 170 can control the display 180 to display an image, and for example, can control a broadcast image input through the tuner 131, an external input image input through the external device interface 135, an image input through the network interface, or an image stored in the memory 140 to be displayed on the display 180. In this case, the image displayed on the display 180 can be a still image or a moving image, and can be a 2D image or a 3D image.

In addition, the controller 170 can control the content stored in the display device 100, or the received broadcast content, or the external input content input from the outside to be played, and the content can be in various forms such as a broadcast image, an external input image, an audio file, a still image, a connected web screen, and a document file.

The wireless communication interface 173 can communicate with an external device through wired or wireless communication. The wireless communication interface 173 can perform short range communication with an external device. To this end, the wireless communication interface 173 can support short range communication by using at least one of Bluetooth™, Radio Frequency Identification (RFID), Infrared Data Association (IrDA), UWB (Ultra Wideband), ZigBee, NFC (Near Field Communication), Wi-Fi (Wireless-Fidelity), Wi-Fi Direct, and Wireless USB (Wireless Universal Serial Bus) technologies. The wireless communication interface 173 can support wireless communication between the display device 100 and a wireless communication system, between the display device 100 and another display device 100, or between the display device 100 and a network where the display device (100, or an external server) is located through a short range wireless communication network (Wireless Area Networks). The short range wireless communication network can be a short range wireless personal area network (Wireless Personal Area Networks).

Here, the other display device 100 may be a wearable device (e.g., a smartwatch, smart glass, a head mounted display (HMD)) or a mobile terminal such as a smart phone that can exchange data with the display device 100 according to the present invention (or can be linked). The wireless communication interface 173 may detect (or recognize) a wearable device capable of communication around the display device 100.

Furthermore, if the detected wearable device is a device authenticated to communicate with the display device 100 according to the present invention, the controller 170 may transmit at least a part of the data processed in the display device 100 to the wearable device through the wireless communication interface 173. Therefore, the user of the wearable device may use the data processed in the display device 100 through the wearable device.

The display 180 can generate a driving signal by converting a video signal, a data signal, an OSD signal processed by the controller 170 or a video signal, data signal, etc. received from an external device interface 135 into R, G, and B signals, respectively.

Meanwhile, since the display device 100 illustrated in FIG. 1 is only an embodiment of the present invention, some of the illustrated components may be integrated, added, or omitted depending on the specifications of the display device 100 actually implemented.

That is, two or more components may be combined into one component, or one component may be subdivided into two or more components, as needed. In addition, the functions performed by each block are for explaining an embodiment of the present invention, and the specific operations or devices thereof do not limit the scope of the present invention.

According to another embodiment of the present invention, the display device 100 may receive and play back an image through a network interface 133 or an external device interface 135 without having a tuner 131 and a demodulator 132, unlike that illustrated in FIG. 1.

For example, the display device 100 may be implemented as a separate image processing device, such as a set-top box for receiving contents according to broadcast signals or various network services, and a content playback device for playing back contents input from the image processing device.

In this case, the operation method of the display device according to the embodiment of the present invention described below may be performed by not only the display device 100 described with reference to FIG. 1, but also by any one of the image processing devices, such as the separated set-top box, or the content playback device having the display 180 and the audio output unit 185.

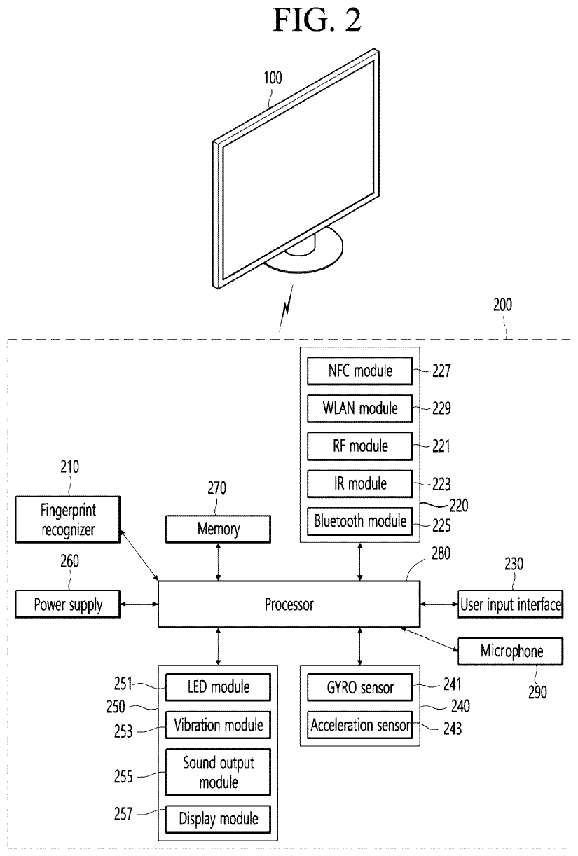

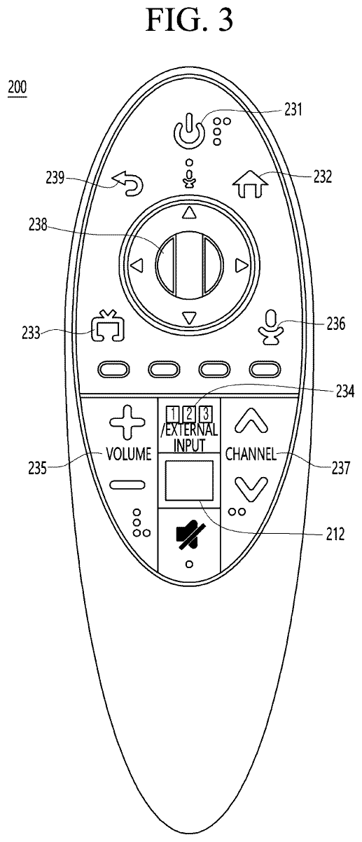

Next, a remote control device according to an embodiment of the present invention will be described with reference to FIGS. 2 and 3.

FIG. 2 is a block diagram of a remote control device according to an embodiment of the present invention, and FIG. 3 illustrates an actual configuration example of a remote control device 200 according to an embodiment of the present invention.

First, referring to FIG. 2, the remote control device 200 may include a fingerprint recognition device 210, a wireless communication circuit 220, a user input interface 230, a sensor 240, an output interface 250, a power supply circuit 260, a memory 270, a controller 280, and a microphone 290.

Referring to FIG. 2, the wireless communication circuit 220 transmits and receives signals with any one of the display devices according to the embodiments of the present invention described above.

The remote control device 200 may be equipped with an RF circuit 221 capable of transmitting and receiving signals with the display device 100 according to an RF communication standard, and an IR circuit 223 capable of transmitting and receiving signals with the display device 100 according to an IR communication standard. In addition, the remote control device 200 may be equipped with a Bluetooth circuit 225 capable of transmitting and receiving signals with the display device 100 according to the Bluetooth communication standard. In addition, the remote control device 200 may be equipped with an NFC circuit 227 capable of transmitting and receiving signals with the display device 100 according to the Near Field Communication (NFC) communication standard, and may be equipped with a WLAN circuit 229 capable of transmitting and receiving signals with the display device 100 according to the Wireless LAN (WLAN) communication standard.

In addition, the remote control device 200 transmits a signal containing information about the movement of the remote control device 200 to the display device 100 through the wireless communication circuit 220.

Meanwhile, the remote control device 200 can receive a signal transmitted by the display device 100 through the RF circuit 221, and can transmit commands for power on/off, channel change, volume change, etc. to the display device 100 through the IR circuit 223 as needed.

The user input interface 230 can be composed of a keypad, a button, a touch pad, or a touch screen. The user can input a command related to the display device 100 into the remote control device 200 by operating the user input interface 230. If the user input interface 230 has a hard key button, the user can input a command related to the display device 100 into the remote control device 200 through a push operation of the hard key button. This will be described with reference to FIG. 3.

Referring to FIG. 3, the remote control device 200 can include a plurality of buttons. The plurality of buttons may include a fingerprint recognition button 212, a power button 231, a home button 232, a live button 233, an external input button 234, a volume control button 235, a speech recognition button 236, a channel change button 237, a confirmation button 238, and a back button 239.

The fingerprint recognition button 212 may be a button for recognizing a user's fingerprint. In one embodiment, the fingerprint recognition button 212 may be capable of a push operation, and may receive a push operation and a fingerprint recognition operation.

The power button 231 may be a button for turning the power of the display device 100 on/off.

The home button 232 may be a button for moving to the home screen of the display device 100.

The live button 233 may be a button for displaying a real-time broadcast program.

The external input button 234 may be a button for receiving an external input connected to the display device 100.

The volume control button 235 may be a button for adjusting the size of the volume output by the display device 100.

The speech recognition button 236 may be a button for receiving a user's speech and recognizing the received speech.

The channel change button 237 may be a button for receiving a broadcast signal of a specific broadcast channel.

The confirmation button 238 may be a button for selecting a specific function, and the back button 239 may be a button for returning to the previous screen.

FIG. 2 will be described again.

If the user input interface 230 has a touch screen, the user can input a command related to the display device 100 to the remote control device 200 by touching the soft key of the touch screen. In addition, the user input interface 230 can have various types of input means that the user can operate, such as a scroll key or a jog key, and this embodiment does not limit the scope of the rights of the present invention.

The sensor 240 can have a gyro sensor 241 or an acceleration sensor 243, and the gyro sensor 241 can sense information about the movement of the remote control device 200.

For example, the gyro sensor 241 can sense information about the operation of the remote control device 200 based on the x, y, and z axes, and the acceleration sensor 243 can sense information about the movement speed of the remote control device 200. Meanwhile, the remote control device 200 may further be equipped with a distance measuring sensor, so as to sense the distance to the display 180 of the display device 100.

The output interface 250 may output a video or audio signal corresponding to the operation of the user input interface 230 or the signal transmitted from the display device 100.

The user may recognize whether the user input interface 230 is being operated or whether the display device 100 is being controlled through the output interface 250.

For example, the output interface 250 may be equipped with an LED 251 that lights up when the user input interface 230 is operated or a signal is transmitted and received with the display device 100 through the wireless communication unit 225, a vibrator 253 that generates vibration, a speaker 255 that outputs sound, or a display 257 that outputs an image.

In addition, the power supply circuit 260 supplies power to the remote control device 200, and power waste can be reduced by stopping the power supply when the remote control device 200 does not move for a predetermined period of time.

The power supply circuit 260 can resume the power supply when a predetermined key provided in the remote control device 200 is operated.

The memory 270 can store various types of programs, application data, etc. required for the control or operation of the remote control device 200.

When the remote control device 200 wirelessly transmits and receives signals through the display device 100 and the RF circuit 221, the remote control device 200 and the display device 100 transmit and receive signals through a predetermined frequency band.

The controller 280 of the remote control device 200 can store and refer to information about the frequency band, etc., that can wirelessly transmit and receive signals with the display device 100 paired with the remote control device 200, in the memory 270.

The controller 280 controls all matters related to the control of the remote control device 200. The controller 280 can transmit a signal corresponding to a predetermined key operation of the user input interface 230 or a signal corresponding to the movement of the remote control device 200 sensed by the sensor 240 to the display device 100 through the wireless communication unit 225.

In addition, the microphone 290 of the remote control device 200 can obtain a speech.

A plurality of microphones 290 can be provided.

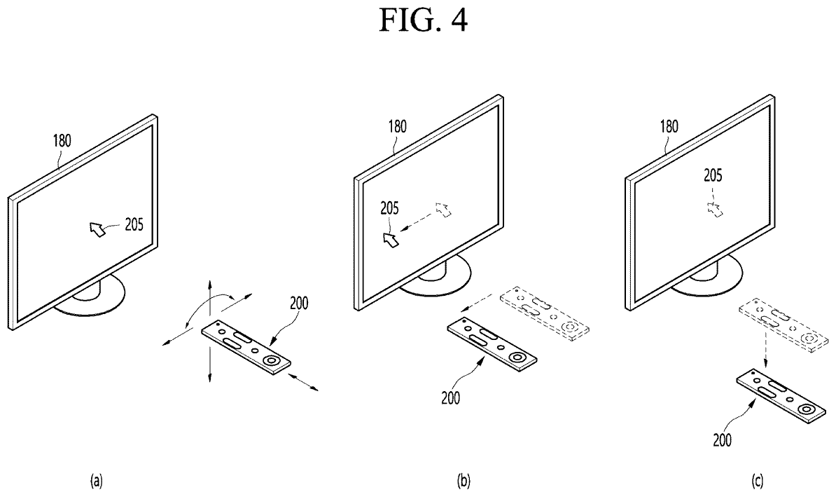

Next, FIG. 4 is described.

FIG. 4 illustrates an example of utilizing a remote control device according to an embodiment of the present invention.

FIG. 4(a) exemplifies that a pointer 205 corresponding to a remote control device 200 is displayed on a display 180.

A user can move or rotate the remote control device 200 up and down, left and right. The pointer 205 displayed on the display 180 of the display device 100 corresponds to the movement of the remote control device 200. Since the pointer 205 displayed on the display 180 of the display device 100 moves and is displayed according to the movement in 3D space, as shown in the drawing, the remote control device 200 can be called a space remote control.

FIG. 4(b) exemplifies that when a user moves the remote control device 200 to the left, the pointer 205 displayed on the display 180 of the display device 100 also moves to the left in response.

Information about the movement of the remote control device 200 detected through the sensor of the remote control device 200 is transmitted to the display device 100. The display device 100 can calculate the coordinates of the pointer 205 from the information about the movement of the remote control device 200. The display device 100 can display the pointer 205 corresponding to the calculated coordinates.

FIG. 4(c) exemplifies a case where a user moves the remote control device 200 away from the display 180 while pressing a specific button in the remote control device 200. As a result, a selection area in the display 180 corresponding to the pointer 205 can be zoomed in and displayed in an enlarged manner.

Conversely, when the user moves the remote control device 200 closer to the display 180, the selection area in the display 180 corresponding to the pointer 205 may be zoomed out and displayed in a reduced size.

On the other hand, when the remote control device 200 moves away from the display 180, the selection area may be zoomed out, and when the remote control device 200 moves closer to the display 180, the selection area may be zoomed in.

In addition, when a specific button in the remote control device 200 is pressed, the recognition of up, down, left, and right movements may be excluded. That is, when the remote control device 200 moves away from or closer to the display 180, the up, down, left, and right movements may not be recognized, and only the forward and backward movements may be recognized. When a specific button in the remote control device 200 is not pressed, only the pointer 205 moves according to the up, down, left, and right movements of the remote control device 200.

Meanwhile, the moving speed or moving direction of the pointer 205 may correspond to the moving speed or moving direction of the remote control device 200.

Meanwhile, the pointer in this specification means an object displayed on the display 180 in response to the operation of the remote control device 200. Therefore, objects of various shapes other than the arrow shape illustrated in the drawing as the pointer 205 are possible. For example, it may be a concept including a point, a cursor, a prompt, a thick outline, etc. In addition, the pointer 205 may be displayed corresponding to one point of the horizontal and vertical axes on the display 180, and may also be displayed corresponding to multiple points such as a line or a surface.

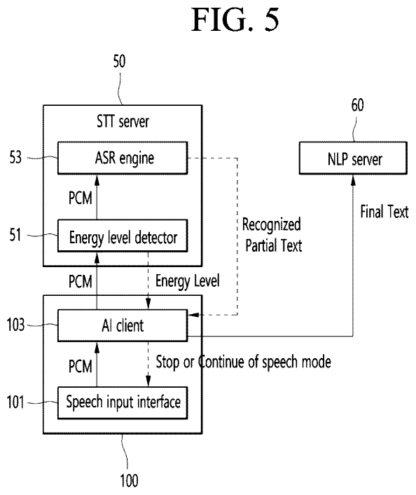

FIG. 5 is a drawing explaining a process for recognizing the endpoint of a speech input according to a conventional technology.

Referring to FIG. 5, a speech input interface 101 of a display device 100 can obtain a speech input and convert a speech signal corresponding to the obtained speech input into a pulse width modulation (PCM) signal.

The speech input interface 101 can transmit the converted PCM signal to an artificial intelligence (AI) client 103.

The AI client 103 can transmit the PCM signal to a Speech To Text (STT) server 50.

The STT (Speech To Text) server 50 can include an energy level detector 51 and an Automatic Speech Recognition (ASR) engine 53.

The energy level detector 51 can detect the energy level of the PCM signal.

The energy level detector 51 can transmit the PCM signal received from the AI client 103 to the ASR engine 53.

The ASR engine 53 can convert the PCM signal in digital form into text.

The STT server 50 can transmit the energy level of the PCM signal and the converted text to the AI client 103.

The AI client 103 can determine that the user's speech input is ended when the energy level of the PCM signal is lower than a preset level. That is, the AI client 103 can determine that the endpoint of the utterance is detected when the energy level of the PCM signal is lower than a preset level.

If the AI client 103 determines that the speech endpoint has been detected, the AI client 103 can transmit the text to the NLP (Natural Language Processing) server 60.

The NLP server 60 can obtain analysis result information including the intent analysis result of the text based on the received text, and transmit the obtained analysis result information to the AI client 103.

In this way, according to the conventional technology, the speech endpoint was detected using the energy level of the PCM signal corresponding to the speech input.

However, even when the actual user's speech has ended, the performance of the speech recognition may continue as the surrounding noise or noise is recognized.

Accordingly, the user may be provided with the performance result of the speech recognition that he or she does not want, causing considerable inconvenience.

In the following embodiments, a method for more accurately detecting the speech endpoint for the user's speech input is proposed.

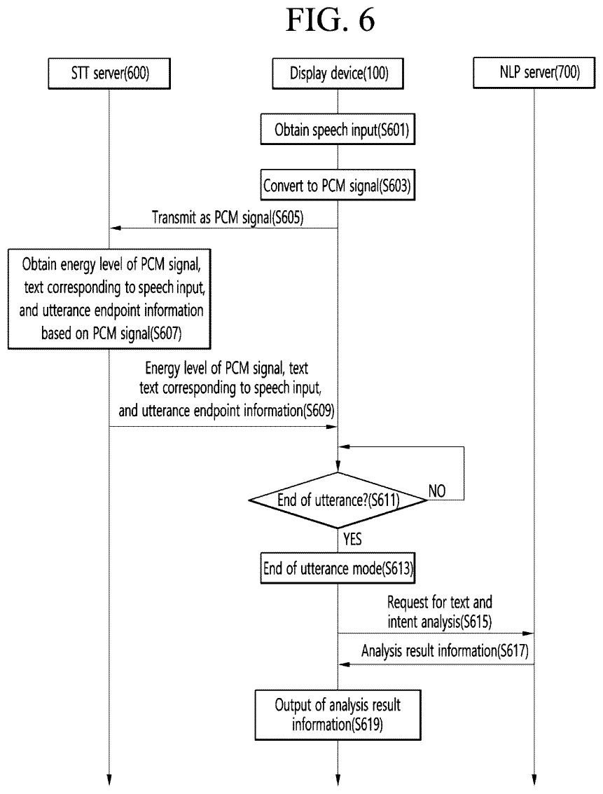

FIG. 6 is a ladder diagram illustrating an operation method of a system according to an embodiment of the present disclosure.

Referring to FIG. 6, the system may include a display device 100, an STT server 600, and an NLP server 700.

The controller 170 of the display device 100 obtains a speech input spoken by a user (S601).

In one embodiment, the controller 170 may receive a speech input from a remote control device 200. The controller 170 may receive a speech input from the remote control device 200 through a user input interface 150. The user may speak a speech to the remote control device 200.

In another embodiment, the controller 170 may receive a speech input from a microphone connected to an external device interface 135 of the display device 100.

In another embodiment, the controller 170 may receive a speech input through a microphone provided in the display device 100.

The controller 170 of the display device 100 converts a speech signal corresponding to the obtained speech input into a PCM signal (S603).

The controller 170 may convert an analog speech signal into a digital pulse code modulation signal. For this purpose, the controller 170 may further include a PCM converter.

The controller 170 of the display device 100 can transmit the converted PCM signal to the STT server 600 through the network interface 133 (S605).

The controller 170 can transmit the PCM signal in real time or periodically through the network interface 133. This is because the speech input can be received continuously.

The STT server 600 can obtain the energy level of the PCM signal, the text corresponding to the speech input, and the speech endpoint information based on the received PCM signal (S607).

The energy level of the PCM signal indicates the size of the PCM signal, and the unit can be expressed in dB.

The STT server 600 can convert the PCM signal into text data through the STT engine (or ASR engine) to obtain the text corresponding to the speech input.

In one embodiment, the speech endpoint information can be the reliability score of the converted text.

The STT server 600 can calculate the reliability score of the text through the endpoint detector described below. The endpoint detector can detect the endpoint of the text by assigning a part of speech to each word of the text and analyzing the text pattern according to the assignment result. This will be described later.

The reliability score can be a criterion for determining whether the speech of the speech input has ended.

The reliability score can have a value between 0 and 1. The larger the reliability score, the greater the probability that the endpoint of the speech will be detected, and the smaller the reliability score, the less the probability that the endpoint of the speech will be detected.

In another embodiment, the utterance endpoint information can include information indicating whether the speech input corresponding to the converted text is the utterance endpoint. For example, the utterance endpoint information can include a value indicating that it is the utterance endpoint (End) or a value indicating that the utterance is not ended (Continuous).

The STT server 600 can transmit the energy level of the PCM signal, the text corresponding to the speech input, and the utterance endpoint information to the display device 100 (S609).

The controller 170 of the display device 100 can determine whether the user's speech is ended based on the energy level of the PCM signal and the speech endpoint information (S611).

In one embodiment, the controller 170 may determine that the user's speech is ended if the reliability score included in the speech endpoint information is equal to or greater than a preset score and the energy level of the PCM signal is less than a preset first level. Here, the preset score may be 0.8 and the preset first level may be 12 dB, but this is only an example.

The reliability score may be a score indicating the probability of the speech endpoint of the speech input.

In another embodiment, the controller 170 may determine that the user's speech is ended if the speech endpoint information includes a value (End) indicating that the speech endpoint of the speech input is ended and the energy level of the PCM signal is less than a preset first level.

In one embodiment, the controller 170 may determine that the user's speech is not ended if the reliability score included in the speech endpoint information is equal to or greater than a preset score and the energy level of the PCM signal is equal to or greater than a preset second level. Here, the preset score may be 0.8 and the second level may be 50 dB.

That is, even if the reliability score included in the speech endpoint information is equal to or greater than a preset score, the controller 170 may determine that the speech is not ended if the energy level of the PCM signal is very large.

In another embodiment, the controller 170 may determine that the user's speech is not ended if the speech endpoint information includes a value (End) indicating that it is a speech endpoint of a speech input and the energy level of the PCM signal is equal to or greater than a preset second level.

That is, even if the utterance endpoint information includes a value indicating the utterance end, the controller 170 may determine that the utterance is not ended if the energy level of the PCM signal is very high.

If the controller 170 of the display device 100 determines that the user's utterance has ended, it terminates the utterance mode (S613).

In one embodiment, the utterance mode may be named a speech recognition mode.

The utterance mode may be a mode that receives the speech spoken by the user and outputs an analysis result for the received speech.

Termination of the utterance mode may indicate ignoring additionally input speech input until the speech recognition result for the speech input is output.

That is, even if the controller 170 receives the speech input, it may not perform processing for it.

Termination of the utterance mode may be an operation that deactivates speech recognition.

The controller 170 of the display device 100 can transmit a request for text and text intent analysis to the NLP server 700 (S615).

The NLP server 700 can analyze the intent of the text based on the text received from the display device 100. The NLP server 700 can generate analysis result information indicating the intent analysis result.

The NLP server 700 can sequentially perform a morphological analysis step, a syntactic analysis step, a speech act analysis step, and a dialogue processing step on the text data to generate analysis result information.

The morphological analysis step is a step for classifying text data corresponding to the user's spoken speech into morpheme units, which are the smallest units having meaning, and determining which part of speech each classified morpheme has.

The syntactic analysis step is the step that uses the results of the morphological analysis step to divide text data into noun phrases, verb phrases, and adjective phrases, and determines what kind of relationship exists between each of the divided phrases.

Through the syntactic analysis step, the subject, object, and modifiers of the speech spoken by the user can be determined.

The speech act analysis step is a step for analyzing the intention of the user's speech using the results of the syntactic analysis step. Specifically, the speech act analysis step is a step for determining the intention of the sentence, such as whether the user is asking a question, making a request, or simply expressing an emotion.

The dialogue processing step is a step for determining whether to answer the user's speech, respond, or ask a question asking for additional information using the results of the speech act analysis step.

After the dialogue processing step, the NLP server 700 can generate analysis result information including at least one of an answer, a response, and an inquiry for additional information for the intention of the user's speech.

The NLP server 700 can transmit a search request to a search server (not shown) to search for information that matches the user's speech intention and receive search information corresponding to the search request.

If the user's speech intention is to search for content, the search information can include information about the searched content, and the analysis result information can include search information.

The controller 170 of the display device 100 can receive analysis result information indicating the intent analysis of the text from the NLP server 700 through the network interface 133 (S617).

The controller 170 of the display device 100 can output the received analysis result information (S619).

In one embodiment, the controller 170 may display the analysis result information through the display 180.

In another embodiment, the controller 170 may output the analysis result information in audio form through the speaker 185.

In this way, according to the embodiment of the present disclosure, the end of speech can be accurately recognized by using text analysis and energy level for speech input. Accordingly, unnecessary speech recognition can be prevented from being performed.

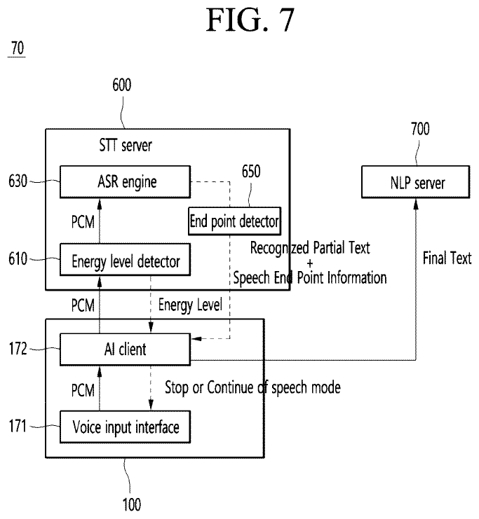

Next, FIG. 7 will be described.

FIG. 7 is a diagram illustrating a process of performing intent analysis by detecting an endpoint of an utterance according to an embodiment of the present disclosure.

A speech recognition system 70 may include a display device 100, an STT server 600, and an NLP server 700.

The STT server 600 and the NLP server 700 may be configured as a single server.

Referring to FIG. 7, the display device 100 may include a speech input interface 171 and an AI client 172.

The speech input interface 171 and the AI client 172 may be included in the controller 170.

The AI client 172 may be included in the network interface 133.

The speech input interface 171 can receive speech input through a microphone equipped in a remote control device 200 or a display device 100.

The speech input interface 171 can convert a speech signal corresponding to the received speech input into a PCM signal.

The AI client 172 can transmit the converted PCM signal to the STT server 600.

The STT server 600 can include an energy level detector 610, an ASR engine 630, and an endpoint detector 650.

The energy level detector 610 can detect an energy level of a PCM signal corresponding to a speech input received from the AI client 172. The unit of the energy level can be dB.

The energy level detector 610 can transmit the detected energy level to the AI client 172.

The ASR engine 630 can convert the PCM signal into text data. The ASR engine 630 can transmit the converted text data to the AI client 172.

The endpoint detector 650 can generate utterance endpoint information based on the text data output from the ASR engine 630.

In one embodiment, the utterance endpoint information may include information indicating whether the utterance of the speech input is an endpoint. In this case, the utterance endpoint information may include one of a value identifying the endpoint of the utterance (End) and a value identifying the endpoint of the utterance (Continue).

In another embodiment, the utterance endpoint information may include a reliability score for the endpoint of the utterance of the speech input. The reliability score may increase as the utterance is closer to the endpoint of the utterance, and may decrease as the utterance is farther from the endpoint of the utterance.

The reliability score may have a value between 0 and 1.

The endpoint detector 650 may generate the utterance endpoint information through part-of-speech analysis, pattern analysis, and symbol analysis of text data.

The process of generating the utterance endpoint information by the endpoint detector 650 is described with reference to the following drawings.

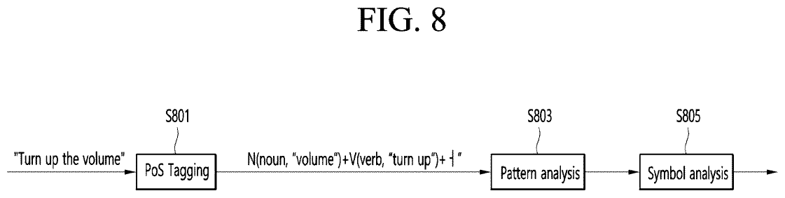

FIG. 8 is a diagram illustrating a process in which an endpoint detector generates utterance endpoint information according to an embodiment of the present disclosure.

Referring to FIG. 8, an endpoint detector 650 can sequentially perform part-of-speech analysis (S801), pattern analysis (S803), and symbol analysis (S805) of text corresponding to a speech input.

For example, it is assumed that the endpoint detector 650 generates utterance endpoint information for the text <Volume Up>.

Part-of-speech analysis (S801) may be a process of attaching a part-of-speech to each word that constitutes the text. The endpoint detector 650 may match a noun to the word <Volume> and a verb to the stem <OLLI>.

In addition, the endpoint detector 650 may also classify the suffix <┤>.

Pattern analysis (S803) may be a process of recognizing the end of a text by analyzing the pattern of the text after the part-of-speech analysis. For example, the endpoint detector 650 may determine whether the ending <┤> of the verb <OLLI> is the end of the text.

In one embodiment, the endpoint detector 650 may generate a value identifying the end of an utterance if the ending <┤> following the verb <OLLI> indicates the end of the text.

In another embodiment, the endpoint detector 650 may calculate a reliability score for the end of an utterance as a large value if the ending <┤> following the verb <OLLI> has a high probability of indicating the end of the text.

Symbol analysis (S805) may be a process of determining the end of a text by referring to symbols (periods, question marks, exclamation marks) for each language.

Symbol analysis (S805) may be an optional process.

The endpoint detector 650 may recognize the word <Up> and recognize the exclamation mark, which is a symbol that is already matched to the word, to recognize the endpoint of the utterance.

Again, FIG. 7 will be described.

The STT server 600 may further be equipped with a communication interface (not shown) for performing communication with the display device 100. The communication interface of the STT server 600 may transmit the energy level of the PCM signal, the converted text data, and the utterance endpoint information to the AI client 172.

In one embodiment, the AI client 172 may determine that the utterance endpoint is detected when the energy level of the PCM signal is less than a preset first level and the utterance endpoint information includes a value indicating the utterance endpoint.

In another embodiment, the AI client 172 may determine that an utterance endpoint is detected if the energy level of the PCM signal is below a preset first level for a certain period of time and the utterance endpoint information includes a value indicating the utterance endpoint.

In another embodiment, in one embodiment, the AI client 172 may determine that the utterance endpoint is detected when the energy level of the PCM signal is less than the preset first level and the reliability score included in the utterance endpoint information is greater than or equal to the preset score.

In another embodiment, in one embodiment, the AI client 172 may determine that the utterance endpoint is detected when the energy level of the PCM signal is less than the preset first level for a certain period of time and the reliability score included in the utterance endpoint information is greater than or equal to the preset score.

When the AI client 172 determines that the utterance endpoint is detected, it may transmit a command to the speech input interface 171 to terminate the utterance mode.

The speech input interface 171 may terminate the utterance mode according to the received command. The speech input interface 171 may ignore the received speech input until the trigger word is re-recognized.

In addition, if the AI client 172 determines that the utterance endpoint is detected, the AI client 172 can transmit the text received from the STT server 600 to the NLP server 700.

The AI client 172 can receive analysis result information indicating the intent analysis result for the text from the NLP server 700 and output the received analysis result information.

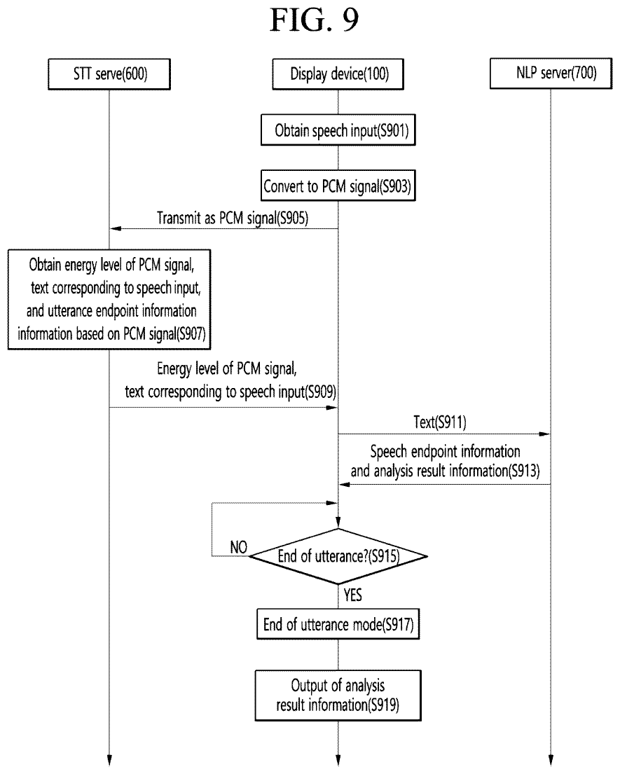

FIG. 9 is a ladder diagram explaining the operation method of the system according to another embodiment of the present disclosure.

The difference from the embodiment of FIG. 6 is that the endpoint detector is included in the NLP server 700 rather than the STT server 600.

A detailed description of the overlapping parts in each step of FIG. 9 with the embodiment of FIG. 6 is omitted.

The controller 170 of the display device 100 can obtain a speech input uttered by the user (S901).

The controller 170 of the display device 100 can convert a speech signal corresponding to the obtained speech input into a PCM signal (S903).

The controller 170 of the display device 100 can transmit the converted PCM signal to the STT server 600 through the network interface 133 (S905).

The controller 170 can transmit the PCM signal in real time or periodically through the network interface 133. This is because the speech input can be received continuously over time.

The STT server 600 can obtain the energy level of the PCM signal and the text corresponding to the speech input based on the received PCM signal (S907).

The STT server 600 can transmit the energy level of the PCM signal and the text corresponding to the speech input to the display device 100 (S909).

The controller 170 of the display device 100 can transmit the received text to the NLP server 700 (S911).

In one embodiment, the controller 170 may transmit the text to the NLP server 700 via the network interface 133 to inquire about the intent analysis and utterance endpoint recognition of the text.

The NLP server 700 can generate utterance endpoint information and analysis result information based on the text received from the display device 100 and transmit them to the display device 100 (S913).

The NLP server 700 may generate utterance endpoint information for the received text via the endpoint detector.

In one embodiment, the NLP server 700 may perform intent analysis of the text and generate analysis result information.

In another embodiment, the NLP server 700 may transmit the analysis result information to the display device 100 only when the utterance endpoint information includes a value (End) indicating that the utterance of the speech input is the endpoint or when the reliability score is equal to or greater than a preset score. This is because the analysis result information may be inaccurate if the utterance is not finished.

In another embodiment, the NLP server 700 may generate the analysis result information only when the utterance endpoint information includes a value (End) indicating that the utterance of the speech input is the endpoint or when the reliability score is equal to or greater than a preset score.

The controller 170 of the display device 100 can determine whether the user's utterance is finished based on the energy level of the PCM signal and the utterance endpoint information (S915).

In one embodiment, the controller 170 may determine that the user's speech has ended if the reliability score included in the speech endpoint information is greater than or equal to a preset score and the energy level of the PCM signal is less than a preset first level. Here, the preset score may be 0.8 and the preset level may be 12 dB, but this is only an example.

In another embodiment, the controller 170 may determine that the user's speech has ended if the speech endpoint information includes a value (End) indicating that the speech endpoint of the speech input has ended and the energy level of the PCM signal is less than a preset first level.

If the controller 170 of the display device 100 can determine that the user's speech has ended, it terminates the speech mode (S917).

The controller 170 of the display device 100 can output the received analysis result information (S919).

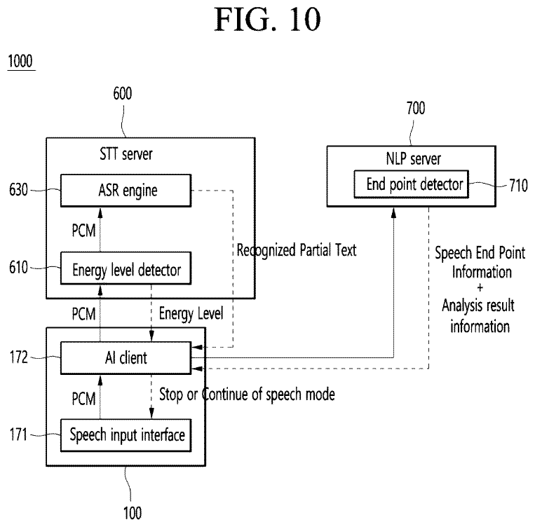

FIG. 10 is a diagram illustrating a process of performing intent analysis by detecting an endpoint of an utterance according to another embodiment of the present disclosure.

A speech recognition system 1000 may include a display device 100, an STT server 600, and an NLP server 700.

The STT server 600 and the NLP server 700 may be configured as a single server.

Referring to FIG. 10, the display device 100 may include a speech input interface 171 and an AI client 172.

The speech input interface 171 and the AI client 172 may be included in the controller 170.

The AI client 172 may be included in the network interface 133.

The speech input interface 171 can receive speech input through a microphone equipped in a remote control device 200 or a display device 100.

The speech input interface 171 can convert a speech signal corresponding to the received speech input into a PCM signal.

The AI client 172 can transmit the converted PCM signal to the STT server 600.

The STT server 600 can include an energy level detector 610 and an ASR engine 630.

The energy level detector 610 can detect an energy level of a PCM signal corresponding to a speech input received from the AI client 172. The unit of the energy level can be dB.

The energy level detector 610 can transmit the detected energy level to the AI client 172.

The ASR engine 630 can convert a PCM signal into text data. The ASR engine 630 can transmit the converted text data to the AI client 172.

The difference from the embodiment of FIG. 7 is that the endpoint detector is equipped in the NLP server 700 rather than the STT server 600.

The NLP server 700 can generate utterance endpoint information and analysis result information based on the text received from the AI client 172.

The NLP server 700 can include an endpoint detector 710 that performs the same function as the endpoint detector 650 described in FIG. 8.

In one embodiment, the utterance endpoint information can include information indicating whether the utterance of the speech input is an endpoint. In this case, the utterance endpoint information can include one of a value identifying that it is an endpoint of the utterance (End) and a value identifying that it is not an endpoint of the utterance (Continue).

In another embodiment, the utterance endpoint information can include a reliability score for the endpoint of the utterance of the speech input. The reliability score may have a larger value as it gets closer to the endpoint of the utterance, and a smaller value as it gets farther away from the endpoint of the utterance.

The reliability score may have a value between 0 and 1.

The endpoint detector 710 may generate utterance endpoint information through part-of-speech analysis, pattern analysis, and symbol analysis of text data, as illustrated in FIG. 8. Additionally, the endpoint detector 710 may generate utterance endpoint information by referring to intent analysis result information for the text.

For example, if the reliability score generated based on part-of-speech analysis, pattern analysis, and symbol analysis of text data is 0.7, and the user's intent is extracted through intent analysis result information, the endpoint detector 710 may add 0.1 to the reliability score. Accordingly, the reliability score may be 0.8.

In one embodiment, the AI client 172 may determine that the user's speech has ended if the energy level received from the STT server 600 is less than a preset first level and the speech endpoint information received from the NLP server 700 includes a value indicating the speech endpoint.

In another embodiment, the AI client 172 may determine that the user's speech has ended if the energy level is less than a preset first level and the reliability score included in the speech endpoint information is greater than or equal to a preset score.

In another embodiment, the AI client 172 may determine that the user's speech has ended if the energy level is less than a preset third level and analysis result information is received, even if the speech endpoint information includes a value (Continue) that does not indicate the speech endpoint. The third level may be 6 dB.

In another embodiment, the AI client 172 may determine that the user's speech is not ended if the speech endpoint information includes a value (Continue) indicating the speech endpoint, and if the energy level is higher than the preset second level, the second level may be 50 dB.

In another embodiment, the AI client 172 may determine that the user's speech is ended if the speech endpoint information includes a value (Continue) indicating the speech endpoint and if the analysis result information is received, the AI client 172 may determine that the user's speech is ended if the energy level is higher than the preset second level.

In this way, according to the embodiment of the present disclosure, whether the user's speech is ended can be accurately determined using the energy level, speech endpoint information, and analysis result information for the user's speech input.

Accordingly, even if the user ends the speech input, speech recognition due to noise can be prevented, and an accurate speech recognition service can be provided according to the end of the speech input.

According to one embodiment of the present invention, the above-described method can be implemented as a code that can be read by a processor on a medium in which a program is recorded. Examples of the medium that can be read by a processor include ROM, RAM, CD-ROM, magnetic tape, floppy disk, optical data storage device, etc.

The display device described above is not limited to the configuration and method of the embodiments described above, and the embodiments can be configured by selectively combining all or part of each embodiment so that various modifications can be made.

What is claimed is:

1. A display device, comprising:
a network interface communicating with a first server and a second server; and
a controller configured to obtain a speech input of a user, transmit a speech signal corresponding to the obtained speech input to the first server, receive an energy level of the speech signal, a text corresponding to the speech input, and utterance endpoint information for the speech input from the first server, and determine whether an utterance of the user has ended based on the energy level and the utterance endpoint information.

2. The display device according to claim 1, wherein the controller is configured to determine that the utterance has ended when the energy level is less than a preset first level and the utterance endpoint information includes a value indicating that the utterance is an endpoint.

3. The display device according to claim 1, the controller is configured to determine that the utterance has ended when the energy level is lower than a preset first level and a reliability score indicating the utterance endpoint included in the utterance endpoint information is equal to or higher than a preset score.

4. The display device according to claim 3, wherein the controller is configured to determine that the utterance has not ended when the energy level is equal to or higher than a preset second level greater than the first level and the reliability score indicating the utterance endpoint included in the utterance endpoint information is equal to or higher than a preset score.

5. The display device according to claim 1, wherein, when it is determined that the utterance of the user has ended, the controller is configured to transmit the text to the second server, receive analysis result information indicating an intent analysis result of the text from the second server, and output the received analysis result information.

6. The display device according to claim 1, wherein, when it is determined that the utterance of the user has ended, the controller is configured to ignore an additional speech input until outputting a speech recognition result for the speech input.

7. The display device according to claim 1, wherein the controller is configured to convert the speech signal into a pulse code modulation (PCM) signal and transmit the converted PCM signal to the first server through the network interface.

8. The display device according to claim 1, wherein the first server is a Speech To Text (STT) server configured to convert a speech into a text, and the second server is a Natural Language Processing (NLP) server.

9. A display device comprising:
a network interface communicating with a first server and a second server; and
a controller configured to obtain a speech of a user, transmit a speech signal corresponding to the obtained speech input to the first server, receive an energy level of the speech signal and a text corresponding to the speech input from the first server, transmit the text to the second server, receive utterance endpoint information for the speech input from the second server, and determine whether a utterance of the user has ended based on the energy level and the utterance endpoint information.

10. The display device according to claim 9, wherein the controller is configured to determine that the utterance has ended when the energy level is less than a preset first level and the utterance endpoint information includes a value indicating that the utterance is an endpoint.

11. The display device according to claim 9, wherein the controller is configured to determine that the utterance has ended when the energy level is less than a preset first level and a reliability score indicating the utterance endpoint included in the utterance endpoint information is greater than or equal to a preset score.

12. The display device according to claim 11, wherein the controller is configured to determine that the utterance has not ended when the energy level is equal to or higher than a preset second level greater than the first level, and the reliability score indicating the utterance endpoint included in the utterance endpoint information is a preset score or higher.

13. The display device according to claim 9, wherein the controller is further configured to receive analysis result information indicating intent analysis for the speech input from the second server through the network interface.

14. The display device according to claim 9, wherein, when the utterance of the user has ended when the controller determines that the user's utterance is ended, the controller is configured to ignore additional speech input until outputting a speech recognition result for the speech input.

15. The display device according to claim 9, wherein the first server is a Speech To Text (STT) server configured to convert a speech into a text, and the second server is a Natural Language Processing (NLP) server.
